(19) United States
(12) Patent Application Publication
(10) Pub. No.: US 2006/0260656 A1
(43) Pub. Date: Nov. 23, 2006

(54) Commercial dishwasher, in particular glass washer

(76) Inventors: Dietrich Berner, Waldstetten (DE); Bjorn Brodowski, Hohberg (DE); Harald Disch, Elzach (DE); Klaus Vollmer, Schutterwald (DE)

Correspondence Address: THOMPSON HINE LLP, P.O Box 8801, DAYTON, OH, 45401-8801, US

(21) Appl. No.: 11/436,420

(22) Filed: May 18, 2006

(30) Foreign Application Priority Data
May 20, 2005 (DE) 102005023492.1

(51) Int. Cl. B08B 3/00; B08B 3/12

(52) U.S. Cl. 134/56 D; 134/182; 134/184

(57) ABSTRACT

Commercial dishwasher, in particular for glasses. A hot-wash section and a cold-wash section are provided in order to provide either heated rinsing liquid or unheated rinsing liquid for the rinsing operation.

The invention relates to a commercial dishwasher, in particular a glass washer, in the form of a batch dishwasher.

Batch dishwashers are designed for loading and unloading batches of items to be washed into and from the treatment chamber. A dish rack which is loaded with the items to be washed either inside or outside the treatment chamber is preferably provided.

Batch dishwashers (also called batch warewashers or box machines) are usually under-counter dishwashers, but may also be top-counter dishwashers or hood-type dishwashers.

The invention is preferably used in under-counter dishwashers.

The invention relates particularly to commercial dishwashers which can also or exclusively be used to clean glasses with a cleaning liquid and then wash them with rinsing liquid.

The invention is preferably used for washing beer glasses in a bar. In a bar, glasses for beer are not rinsed in the same way as glasses for other drinks since beer is preferably served in cold damp glasses. The reason for this is that beer should be served as cold as possible and should also remain cold, but the higher the temperature of the beer glass, the warmer the beer becomes when it is served. However, a higher beer temperature caused by the beer glass impairs the quality and taste of the beer.

At a beer-tap temperature of 4° C. for example, the temperature of the beer should not be higher than approximately 5.8° C. after it is poured into a glass. In order to achieve this, the temperature of the beer glass should be more or less well below 25° C., depending on the weight and shape of the glass.

Beer is often poured into the beer glass immediately after the said beer glass is rinsed. As a result, the temperature of the glass after the rinsing operation has a significant effect on the final temperature of the beer in the beer glass.

In present-day glass washers, the temperature of beer glasses after the normal hot-wash is approximately 50° C. to 65° C. This means that the glasses have to be left standing at room temperature for a few minutes after the rinsing operation in order to cool down, otherwise they are immediately filled with beer again but this significantly reduces the quality of the beer.

The aim of the invention is to achieve the object of designing a commercial dishwasher in such a way that an immediate and rapid cooling effect is achieved when it is switched over from hot post-washing to cold post-washing.

According to the invention, this object is achieved by the features of claim 1.

Accordingly, the invention relates to a commercial dishwasher, in particular a glass washer, in the form of a batch dishwasher, comprising a treatment chamber for holding items to be washed; nozzles in the treatment chamber for spraying liquid onto items to be washed which are in the treatment chamber; characterized by a hot-wash section; a cold-wash section; valves for supplying rinsing liquid from a liquid inflow to the nozzles either through the hot-wash section or through the cold-wash section; and an electrical or electronic control device for automatically controlling the valves by at least one programme stored in the control device.

Further features of the invention can be found in the subclaims.

The invention is described below with reference to the accompanying drawings using preferred embodiments as examples. In the drawings:

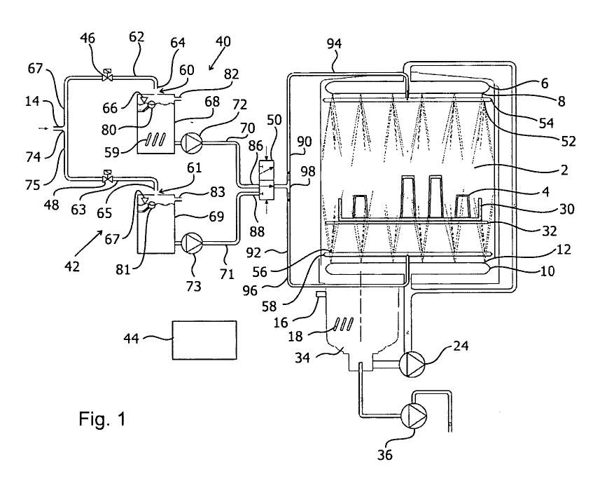

FIG. 1 schematically shows a partial vertical section through a commercial dishwasher according to the invention in the form of a batch dishwasher,

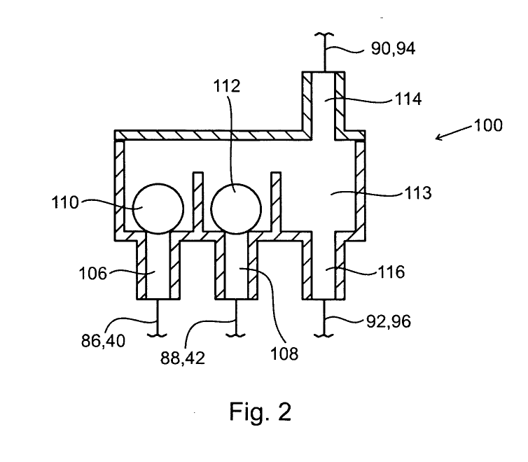

FIG. 2 shows a further embodiment of a detail of the dishwasher according to FIG. 1, and

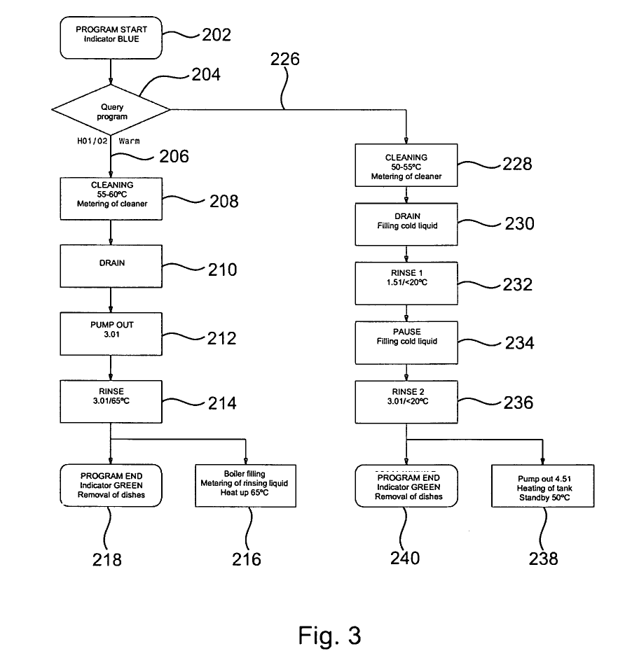

FIG. 3 is a programme flowchart which shows preferred programme sequences according to the invention with a commercial dishwasher according to the invention.

The dishwasher according to the invention shown in FIG. 1 is used particularly to wash glasses, in particular beer glasses, and is in the form of a batch dishwasher. It contains a treatment chamber 2 for holding items 4 to be washed, in particular beer glasses or other glasses which are used to serve drinks. At least one upper cleaning-spray arm 6 having a multiplicity of downwardly directed cleaning-spray nozzles 8 and at least one lower cleaning-spray arm 10 having upwardly directed cleaning-spray nozzles 12 are also provided.

The items 4 to be washed are located in a rack 30 which is situated in the cleaning chamber 2 on supporting surfaces 32.

According to the invention, a hot-wash section 40 and a cold-wash section 42 are provided. A control device 44 and electromagnetically operated valves 46, 48 and 50 which are controlled by it are also provided for supplying rinsing liquid from a water-inflow connection 14 either through the hot-wash section 40 or through the cold-wash section 42 to downwardly directed washing-spray nozzles 52 of upper washing-spray arms 54 and to upwardly directed washing-spray nozzles 56 of lower washing-spray arms 58 in the treatment chamber 2.

In place of just one water-inflow connection 14, a separate water-inflow connection can be provided for each wash section 40, 42.

A tank 34 for holding liquid which is sprayed in the treatment space is located beneath the treatment chamber 2. In the illustrated embodiment, the tank 34 is initially filled via the hot-wash section 40. As an alternative, it may be initially filled via the cold-wash section 42. Furthermore, provision may be made for the tank to be initially filled via both the hot-wash section 40 and the cold-wash section 42.

Rather than filling the tank 34 via a wash section 40, 42, a separate line may be provided for supplying fresh water to the tank 34 (not illustrated).

A cleaner can be supplied to the liquid in the tank 34 through a cleaner-metering device.

During a cleaning operation, the liquid in the tank 34 is pumped to the cleaning-spray arms 6, 10 by a cleaning-liquid pump 24. A tank heater 18 for adjusting the temperature of the cleaning liquid in the tank 34 to a desired cleaning-liquid temperature is arranged in the tank 34.

The liquid can flow out of the tank 34 through an overflow or, as illustrated, be pumped out by a discharge pump 36.

The upper spray arms 6 and 54 are located above the region of the items 4 to be washed, and the lower spray arms 10 and 58 are located below the region of the items 4 to be washed, in the treatment chamber 2.

The hot-wash section 40 contains a return-prevention arrangement 60, for example in the form of an air gap 60 between the downstream end 64 of an inlet line 62 and the maximum liquid level 66 in a storage container 68. The inlet line 62 contains one valve 46 of the said valves and its upstream starting portion 67 is connected to the water-inflow connection 14. A heater, preferably an electrical heating element 59, for heating up the rinsing liquid in the hot-wash section 40 can be arranged at a suitable location, preferably in the storage container 68.

An outlet line 70 of the storage container 68 contains a washing-liquid pump 72 for conveying the washing liquid through a further valve 50 of the said valves, if this valve is in the position shown in FIG. 1, to the washing-spray nozzles 52 and 56 of the washing-spray arms 54 and 58. In the position shown in FIG. 1, this valve 50 blocks the supply of washing liquid through the cold-wash section 42 to the washing-spray arms 54 and 58. This valve 50 is, for example, a 3/2-way valve according to FIG. 1. According to other embodiments, other elements can also be used in place of this valve 50, for example a double turnout or a double T-piece with a return-flow safety device or two electromagnetically operated valves and one T-piece or double solenoid valves with a return-flow safety device or two non-return flaps and one T-piece or other elements for supplying rinsing liquid either through the hot-wash section 40 or through the cold-wash section 42 to the washing-spray arms 54 and 58.

According to FIG. 1, the cold-wash section 42 can be formed in the same way as the hot-wash section 40. Accordingly, the cold-wash section 42 contains a return-prevention arrangement 61, for example in the form of an air gap 61 between the downstream end 65 of an inlet line 63 and the maximum liquid level 67 in a storage container 69 of the cold-wash section 42. The inlet line 63 of the cold-wash section 42 contains one valve 48 of the said valves and its upstream line starting portion 75 is connected to the water-inflow connection 14.

An outlet line 71 of the storage container 69 of the cold-wash section 42 contains a washing-liquid pump 73 which can convey cold washing liquid from the storage container 69 to the washing-spray arms 54 and 58 however only when the valve 50, which is in the form of a 3/2-way valve in FIG. 1, is not in the position shown in FIG. 1, but is in the switched over position in which last position however only cold rinsing liquid can be conveyed from the cold-section storage container 69 but hot rinsing liquid cannot be conveyed from the hot-section storage container 68 to the washing-spray arms 54 and 58.

The two storage containers 68 and 69 may have level sensors 80 and 81, respectively, which close the relevant valve 46 or 48 in the inlet line 62 or 63 when the predetermined maximum liquid level 66 or 67 is reached in the relevant storage container 68 and/or 69. The storage containers 68 and 69 can also be provided with an overflow 82 or 83 for limiting a maximum level.

An upstream part of the respective section 40, 42, in particular the storage container 68 or the storage container 69, can be formed without pressure in each case by the two washing-liquid pumps 72, 73. The two washing-liquid pumps 72, 73 can be controlled by the control apparatus 44 in particular.

In the embodiment of FIG. 1, the fresh water, which can be supplied via the water-inflow connection 14 of the dishwasher, is conducted either through the hot-wash section 40 or through the cold-wash section 42. The two inlet lines 62 and 63 of the two sections 40 and 42 are connected to the water-inflow connection 14 via a T-piece 74, for example. It is also possible to provide other connection means, for example valves or a liquid turnout, in place of a T-piece 74 of this type.

The downstream ends 86 and 88 of the hot-wash section 40 and of the cold-wash section 42, respectively, are connected to separate inlets of the valve 50 and can be connected either to the upstream starting portions 90 and 92 of an upper wash line 94 and a lower wash line 96, for example via a T-piece 98. The downstream end of the upper wash line 94 is connected to the upper washing-spray arm 54. The lower wash line 96 is connected to the lower washing-spray arm 58.

Other connection means can also be used in place of the 3/2-way valve 50 and/or in place of the T-piece 98 connected downstream of the said valve.

The rinsing liquid may be fresh water or a solution of rinse agent in fresh water. The rinse agent can be mixed with the fresh water in the hot-wash section 40 and in the cold-wash section 42 separately or is supplied to the two sections 40 and 42 before the fresh water. The rinsing liquid in the cold-wash section 42 is unheated liquid.

FIG. 2 shows a longitudinal section through a double turnout 100 which can be used in place of the elements 3/2-way valve 50 and T-piece 98 shown in FIG. 1. The double turnout contains two inlets 106 and 108 which are each provided with a return-flow safety element 110 or 112 in the form of a non-return valve, and to each of which the end 86 or 88 of the hot-wash section 40 or of the cold-wash section 42 can be connected. On the downstream side of the return-flow safety elements 110 and 112, there is an outlet chamber 113 with outlets 114 and 116. The upstream starting portion 90 of the upper rinse line 94 can be connected to one outlet 114, and the upstream starting portion 92 of the lower rinse line 96 can be connected to the other outlet 116.

The return-flow safety elements 110 and 112 can be formed by balls, for example. If the double turnout 100 is arranged vertically, as illustrated in FIG. 2, the inlet 106 and the inlet 108 are each closed by the weight of the relevant return-flow safety element 110 or 112 as long as it is not acted on by pressurized rinsing liquid.

The control device 44, which is particularly in the form of an electrical control device, an electromechanical control device or preferably an electronic control device, contains at least one programme for cleaning and for rinsing items 4 to be washed, in particular glasses 4, for example beer glasses.

One possible embodiment of a cleaning and rinsing programme of this type is shown in FIG. 3. In FIG. 3, arrows indicate the direction of programme steps which follow one another, and the individual elements have the following meanings: 202 Start of the programme; 204 Decision between a cleaning programme (H01/02) with subsequent hot rinsing and a cleaning programme (COL) with subsequent cold rinsing.

If a programme sequence 206 with cleaning (wash) and subsequent hot rinsing is selected here, a cleaning operation 208 (wash) is first performed, with the items (preferably glasses) to be washed being sprayed with cleaning liquid which has been heated up to a predetermined temperature of, for example, 55 to 60° C. over a predetermined time period of, for example, 45 or 90 seconds; following this, draining 210 can take place, with the items 4 to be washed not being sprayed with liquid but being allowed to drain for a predetermined time period of, for example, 10 seconds; a pumping-out operation 212 then follows for a predetermined time of, for example, 5 seconds, this pumping out at least some of the cleaning liquid which was previously sprayed and has collected in the tank 34 of the dishwasher; this is followed by rinsing 214 with hot rinsing liquid at a predetermined temperature of, for example, 65° C. over a predetermined time period of, for example, 15 seconds; this is followed in a programme step 216 by the rinsing-liquid storage container (for example 68 in FIG. 1) then being filled with rinsing liquid again and this rinsing liquid being heated up to 65° C. for example; following this, the programme ends 218, and the items which have been washed can be removed from the dishwasher.

When the programme sequence 226 with cleaning (wash) and subsequent cold rinsing is chosen during the programme decision 204, the items to be washed are first cleaned with heated-up cleaning liquid at a predetermined temperature of, for example, 50 to 55° C. for a predetermined time period of, for example, 95 seconds in a programme step 228; this is followed in a further method step 230 by a break for the items to be washed for a predetermined time period of, for example, 10 seconds, during which they are not sprayed so that they can drain, it being possible to fill the storage container 69 from FIG. 1 with unheated and thus cold rinsing liquid during this time period; the items 4 to be washed are then sprayed in a first rinsing step 232 and are thus washed with the cold rinsing liquid which is at a temperature below 30° C., preferably below 25° C. and even more preferably below 20° C., but also with the possibility of providing active cooling of the rinsing liquid; the glasses can be cooled to an intermediate temperature of, for example, 30 to 45° C. in the first rinsing step 232, ⅓ of the total amount of rinsing liquid being required for this for example; there is then a brief pause of, for example, 3 seconds in step 234, during which the storage container 69 of the cold-wash section can be filled with cold liquid for example; a second cold rinsing step 236 is performed with the rest of the rinsing liquid, with the glasses being cooled down to their final temperature; the first cold rinsing operation can last for 4 seconds, for example, and the second for 7 seconds, for example; this is followed in a programme step 238 by pumping at least some of the sprayed liquid out of the tank 34 and heating up cleaning liquid in the tank 34 again; the programme then ends in accordance with programme step 240. A quantity of liquid which is equal to the quantity of rinsing liquid which has been supplied in total is preferably pumped out of the tank 34.

As described above, the items 4 to be washed, in particular glasses, are preferably not immediately completely cooled by the cold rinsing, but are gradually cooled in, for example, two (as illustrated in FIG. 3) or more rinsing steps. This is better for the glasses. As an alternative, the items 4 to be washed can be cooled in a single rinsing step.

The invention is immediately executed and has an immediate effect both when switching over from hot to cold rinsing and when switching over from cold to hot rinsing. Only a small quantity of fresh water, for example 4.5 l, is needed for each cold rinsing operation. As a result, a glass temperature of less than 25° C. can be achieved with a rinsing time of, for example, 15 seconds when the temperature of the cold post-washing liquid is below 20° C.

The invention can be realized, for example, in a dishwasher which, according to FIG. 3, contains three programme options, of which two programmes (H01/H02) are provided with hot rinsing and one programme (COL) is provided with cold rinsing. The two programmes with hot rinsing differ only in the time difference between the cleaning phases during cleaning step 208, with a cleaning time of, for example, 45 seconds for one programme, and a cleaning time of, for example, 90 seconds for the other programme. A difference in the programme sequence between the programme with cold rinsing compared to the two programme sequences with hot rinsing may be that sprayed liquid is pumped out of the tank after the cold rinsing, and that the cleaning liquid is heated up between two rinsing cycles or, if the subsequent cleaning and rinsing programme sequence takes place immediately, the cleaning time for the following programme sequence is extended until the preset temperature of the cleaning liquid of, for example, 55° C. has been reached.

Furthermore, a particular programme feature can be provided by means of which, if the dish rack containing the cold glasses is not immediately removed from the dishwasher after the cold rinsing is complete, the cold rinsing operation is repeated each time a predetermined, preferably settable period of time elapses, until the dish rack is removed from the dishwasher, that is to say the cold rinsing operation is repeated here at time intervals which correspond to the period of time.

The condition “dish rack is/has been removed” can be checked by the control device, for example by detecting whether the door or the hood of the dishwasher has been opened after the cold rinsing is complete.

1. Commercial dishwasher, in particular glass washer, in the form of a batch dishwasher, comprising a treatment chamber for holding items to be washed; nozzles in the treatment chamber for spraying rinsing liquid onto the items to be washed which are in the treatment chamber;
characterized by
a hot-wash section which contains a pump for conveying rinsing liquid to the nozzles; a cold-wash section which contains a pump for conveying rinsing liquid to the nozzles; valves for supplying rinsing liquid to the nozzles either through the hot-wash section or through the cold-wash section; and a control device for automatically controlling the valves by at least one programme stored in the control device.

2. Dishwasher according to claim 1,
characterized
in that the hot-wash section contains a heater for heating up the rinsing liquid.

3. Dishwasher according to claim 2,
characterized
in that at least one of the hot-wash section and/or the cold-wash section contains a return-prevention arrangement for preventing liquid from flowing back from the dishwasher through one of the two sections in the direction from the downstream end to the upstream end.

4. Dishwasher according to claim 3,
characterized
in that the pump of the relevant section is arranged downstream of the return-prevention arrangement.

5. Dishwasher according to claim 2,
characterized
in that an upstream portion of at least one of the hot-wash section and/or the cold-wash section is formed without pressure upstream of the relevant pump.

6. Dishwasher according to claim 1,
characterized
in that an upstream liquid-inflow distributor is provided, to which upstream starting portions of the hot-wash section and the cold-wash section are or can be connected.

7. Dishwasher according to claim 6,
characterized
in that a downstream liquid distributor is provided, which can be supplied with rinsing liquid either through the hot-wash section or through the cold-wash section, and which is connected to the nozzles by distributor lines.

8. Dishwasher according to claim 1,
characterized
in that the control device automatically controls the valves in such a way that the items to be washed are gradually cooled to a lower temperature by rinsing liquid from the cold-wash section in at least two steps.

9. Dishwasher according to claim 8,
characterized
in that the control device automatically controls the valves in such a way that if the items which have been washed are not immediately removed from the dishwasher after cold rinsing is complete, the cold rinsing operation is repeated each time a predetermined, preferably settable period of time elapses, until the items which have been washed are removed from the dishwasher.

10. Commercial batch-type dishwasher, comprising:
a treatment chamber for holding items to be washed, nozzles in the treatment chamber for spraying rinsing liquid onto items in the treatment chamber;
a hot-wash section including a first pump for conveying hot rinsing liquid to the nozzles;
a cold-wash section including a second pump for conveying cold rinsing liquid to the nozzles;
at least one valve for controlling delivery of rinsing liquid to the nozzles from either the hot-wash section or the cold-wash section; and
a control device for automatically controlling the first pump, second pump and at least one valve in accordance with a either a first cleaning sequence that has a hot rinsing step during which the first pump is operated to deliver hot rinsing liquid to the nozzles or a second cleaning sequence that has a cold rinsing step during which the second pump is operated to deliver cold rinsing liquid to the nozzles.

11. The commercial batch-type dishwasher of claim 10 wherein the at least one valve includes at least one valve at a downstream side of the and second pumps and at least one valve at an upstream side of the first and second pumps.

12. The commercial batch-type dishwasher of claim 10 wherein the hot-wash section includes a liquid storage container, including a heating element, at an upstream side of the first pump, and the cold-wash section includes a liquid storage chamber at an upstream side of the second pump.

13. The commercial batch-type dishwasher of claim 12 wherein water feeds to the respective liquid storage chambers are arranged such pressure is not formed at an input of the first pump or at an input of the second pump.

14. The commercial batch-type dishwasher of claim 10, wherein during the second cleaning sequence delivery of cold rinsing liquid to the nozzles is controlled in a manner to produce at least first and second cooling steps for items in the treatment chamber.

15. The commercial batch-type dishwasher of claim 14 wherein the delivery of cold rinsing liquid during the first cooling step if for a shorter duration than the deliver of cold rinsing liquid during the second cooling step.

16. The commercial batch-type dishwasher of claim 10 wherein the cold rinsing liquid has a temperature of less than 20° C.
